(19) United States
(12) Patent Application Publication
(10) Pub. No.: US 2018/0345516 A1
(43) Pub. Date: Dec. 6, 2018

(54) ROLLED PAPER CUTTING DEVICE

(71) Applicant: Bryan Perla, West Boylston, MA (US)

(72) Inventor: Bryan Perla, West Boylston, MA (US)

(21) Appl. No.: 15/994,665

(22) Filed: May 31, 2018

Related U.S. Application Data
(60) Provisional application No. 62/670,840, filed on May 13, 2018.
(60) Provisional application No. 62/513,474, filed on Jun. 1, 2017.

(51) Int. Cl. B26D 1/04; B26B 29/06; B65H 35/00

(52) U.S. Cl. CPC B26D 1/045; B26B 29/06; B65H 2701/5112; B26D 2210/11; B65H 35/002

(57) ABSTRACT

The present invention is a rolled paper cutting device and method which safely and easily cuts a variable length sheet of paper from rolled paper, including an adjustable holder for controlling the rolled paper, and a paper cutting blade embedded within a safety slot, the safety slot protecting a user from a blade related injury.

### CROSS-REFERENCE TO RELATED APPLICATIONS

This application claims the benefit under 35 U.S.C. § 119(e) of U.S. Provisional Application No. 62/513,474 filed Jun. 1, 2017, and also claims the benefit under 35 U.S.C. § 119(e) of U.S. Provisional Application No. 62/670,840 filed May 13, 2018, both of which are hereby incorporated by reference.

### STATEMENT REGARDING FEDERALLY SPONSORED RESEARCH OR DEVELOPMENT

This invention has been created without the sponsorship or funding of any federally sponsored research or development program.

### FIELD OF THE INVENTION

This invention is a device that is used for cutting sheets from rolled paper.

### BACKGROUND OF THE INVENTION

Cutting rolled paper is a universal task and tools currently available lead only to universal frustration. The present invention is the universal solution. The outdated way of cutting rolled paper into sheets has never worked very well, because the slice is either jagged, ripped, or crooked. People have been using scissors and EXACTO blades for cutting rolled paper since the 1920s, and these devices are simply not adequate. Current methods and devices waste paper and consumer's time. People have tried blades, knives, and sharper scissors, but those devices are not safe and put the consumer's, including children's, safety in danger. During the holidays, when rolled wrapping paper is most frequently used, and when people have the least amount of time to wrap presents including working with rolled paper, consumers continue to spend hours upon hours fussing with dull scissors and unsafe blades. And ending up with results that are often far from perfect. Without an obvious alternative, these appear to the consumer to be the most effective tools for cutting rolled wrapping paper. How we cut wrapping paper needs to change both for efficiency's and for safety's sake.

These and other difficulties experienced with the prior art devices have been obviated in a novel manner by the present invention.

It is, therefore, an outstanding object of some embodiments of the present invention to solve these problems in a simple way. Simply put, the present invention is a large improvement in cutting rolled wrapping paper and provides a device and method that is efficient and effective.

Another object of some embodiments of the present invention is to make cutting rolled wrapping paper easy.

A further object of some embodiments of present invention is to make a monotonous wrapping task fun.

It is another object of some embodiments of the present invention to improve the cutting of rolled wrapping paper by making the slice free of jaggedness, ripped sections, or crooked cuts.

It is a further object of some embodiments of the present invention to minimize the wasting of rolled paper as well as minimizing the time needed to actually wrap a package with rolled wrapping paper.

It is another object of some embodiments of the present invention to provide a device that is safe for consumers and particularly for children that often are involved in wrapping present during the holidays.

It is another object of some embodiments of the present invention to provide a device that, during the holidays, when rolled wrapping paper is most frequently used, allows for consumers to spend the least amount of time necessary wrapping presents.

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF THE INVENTION

The present invention is a device that is used for cutting sheets from rolled paper. The invention allows users to keep the paper rolled while simultaneously cutting a single sheet of paper safely and with ease. The invention includes a constraining holder for rolled paper, allowing users to engage the embedded cutting blade with an unrolled section of paper to cut off a sheet while simultaneously maintaining control of the paper which remains on the roll. The invention also makes use of a paper cutting blade embedded within a slot to protect the user. The invention furthermore is adjustable to fit varying diameter rolls of paper. The invention works by sliding the device over the paper roll and feeding the paper through a slot in the device. And, once the paper is in the proper position, the user gently pushes the device, producing a cleanly cut slice of paper.

One embodiment of the invention includes a flexible hinge, an embedded blade, a simple construction of durable plastic, a safety lip feature that protects the user's hand from coming in contact with the sharp cutting blade.

### BRIEF DESCRIPTION OF THE DRAWINGS

The character of the invention, however, may best be understood by reference to one of its structural forms, as illustrated by the accompanying drawings, in which:

FIG. 1 shows a front view of an embodiment of the present invention including the holder with a front end and back end, the hinge (living), the full length dispensing interstice (large slit), the safety lip, the partial length knife engagement interstice (small slit), and the embedded paper cutting knife blade (overmold).

FIG. 2 shows a side view of an embodiment of the present invention including the holder, the safety lip, and the knife blade (overmold)

FIG. 3 shows an end view of an embodiment of the present invention including the living hing, the safety lip, the full length dispensing interstice (large slit), and the partial length knife engagement interstice (small slit).

FIG. 4 shows a general view of an embodiment of the present invention with the paper cutting device situated at the starting end of the rolled paper.

FIG. 5 shows a general view of an embodiment of the present invention with the paper cutting device situated at the midway point of the rolled paper, after having sliced half way through the width of the sheet of paper.

FIG. 6 shows a general view of an embodiment of the present invention showing the paper cutting device situated at the finish end of the rolled paper.

### DETAILED DESCRIPTION OF THE INVENTION

The present invention is a paper cutter device that cuts a sheet from rolled paper. The device is a safety enabled paper cutter that also acts as a tool used to hold rolled paper together, preventing it from unrolling and becoming disorganized.

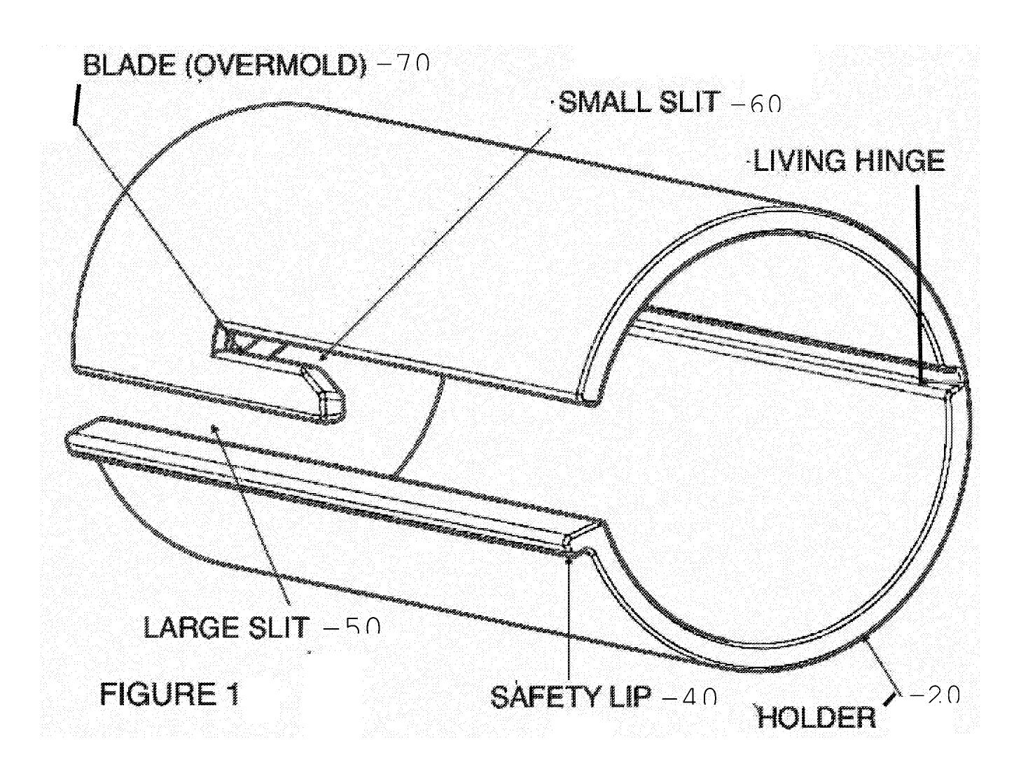

As shown in FIG. 1, the rolled paper cutter 10 comprises a cylindrical rolled paper holder 20, a full length dispensing interstice (large slit) 50, a partial length knife engagement interstice (small slit) 60, and an embedded paper cutting knife blade 70. The partial length knife engagement interstice (small slit) 60 includes the embedded paper cutting knife blade 70 within it, which knife blade 70 provides the means for slicing the rolled paper 80 and causing the sheet of paper 90 to detach from the rolled paper 80. There are various known ways to attach the knife blade to the device itself, including where the blade is held into place in the actual mold and then the plastic is molded around the blade through injection molding. Another possible way of attaching the blade to the device is to mold the main part of the device along with a blade cover separately and then assemble it after production using ultrasonic welding to fuse the blade cover over the blade and to the plastic main part.

The method of cutting rolled paper using the present device includes extending the sheet of paper out to its appropriate length, positioning the holder 20 at the starting end 100 of the rolled paper 80, sliding the edge of the sheet of paper 90 into the partial length knife engagement interstice (small slit) 60, engaging the sheet of paper 90 with the knife blade 70 by moving the paper cutting device 20 forward towards the finish end 110 of the rolled paper 80, while the rolled paper 80 is guided within the partial length knife engagement interstice (small slit) 60, and at the point where the paper cutting device 20 reaches the finish end 110 of the rolled paper 80, cleanly slicing off the sheet of paper 90 from the rolled paper 80.

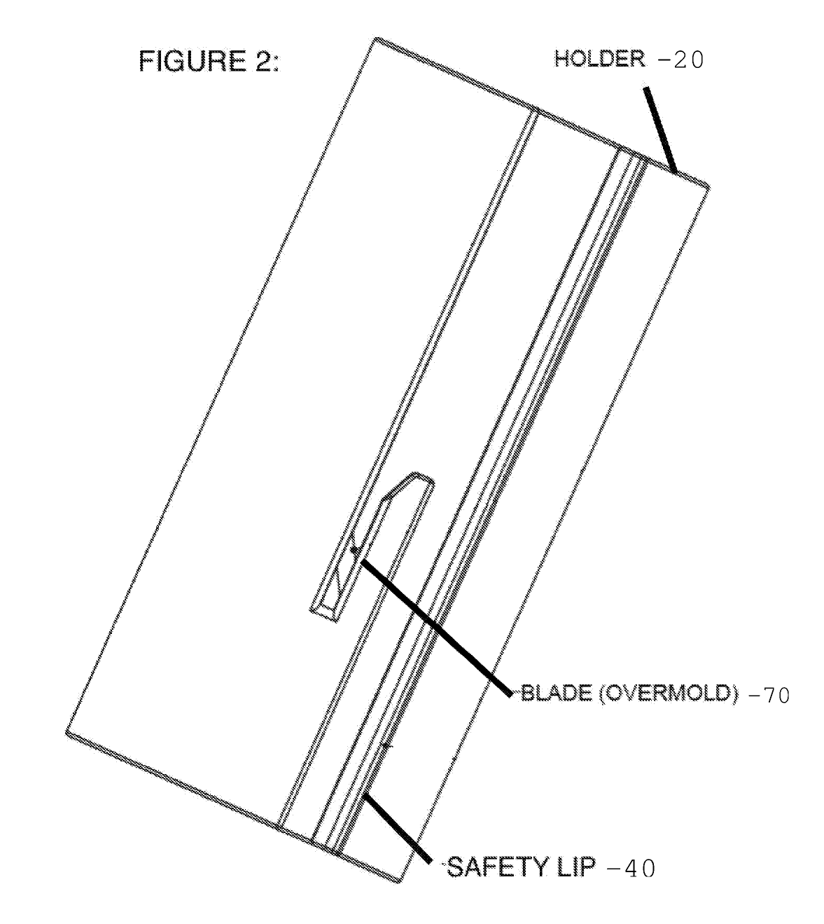

As shown in FIG. 2, the paper cutter 10 comprises a safety lip 40 that runs parallel to and on the outward facing edge of the full length dispensing interstice (large slit) 50. The full length dispensing interstice (large slit) 50 is the means by which the sheet of paper 90 is properly dispensed and then cut to the appropriate length. There is also a partial length knife engagement interstice (small slit) 60 which acts as a guide for the sheet of paper 90 during the cutting process.

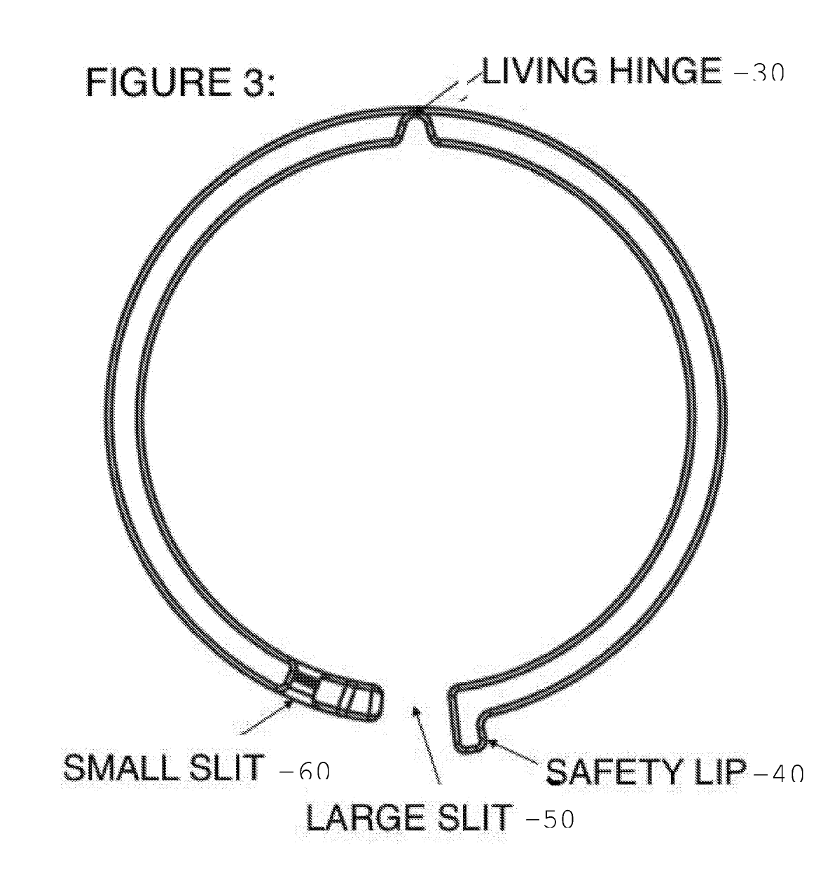

As shown in FIG. 3, the paper cutter device 10 is generally cylindrical which enabling the holder 20 to fit around rolled paper 80 (such as wrapping paper). The holder 20 is able to compress using the hinge (living) 30 in order for it to fit snuggly around the rolled paper even as the circumference of the rolled paper 80 decreases as it is gradually unrolled with use.

To summarize, the rolled paper cutter device 10 allows a user to cut the rolled paper 80 (such as wrapping paper) more effectively, efficiently, and safely.

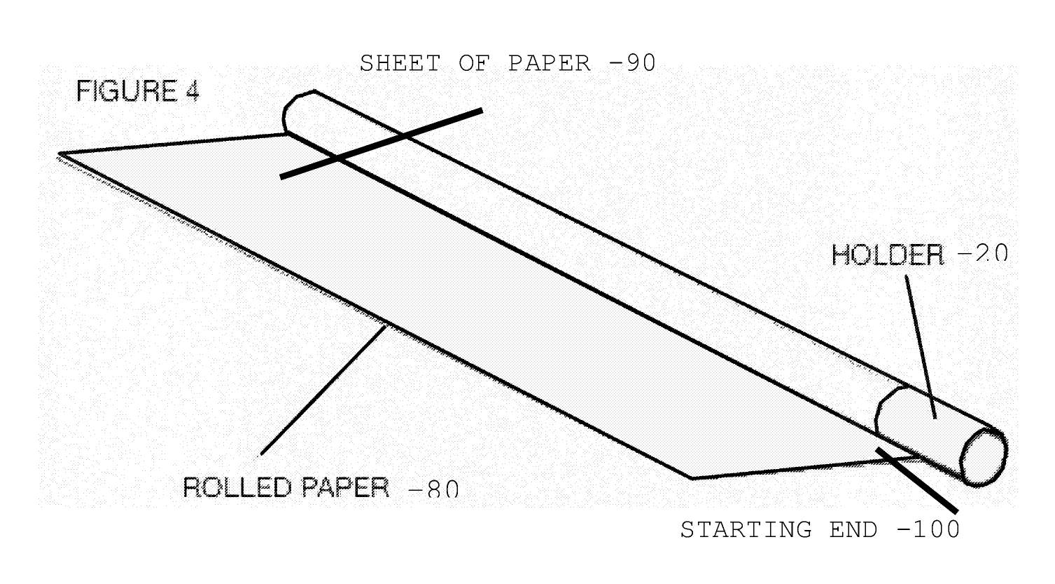

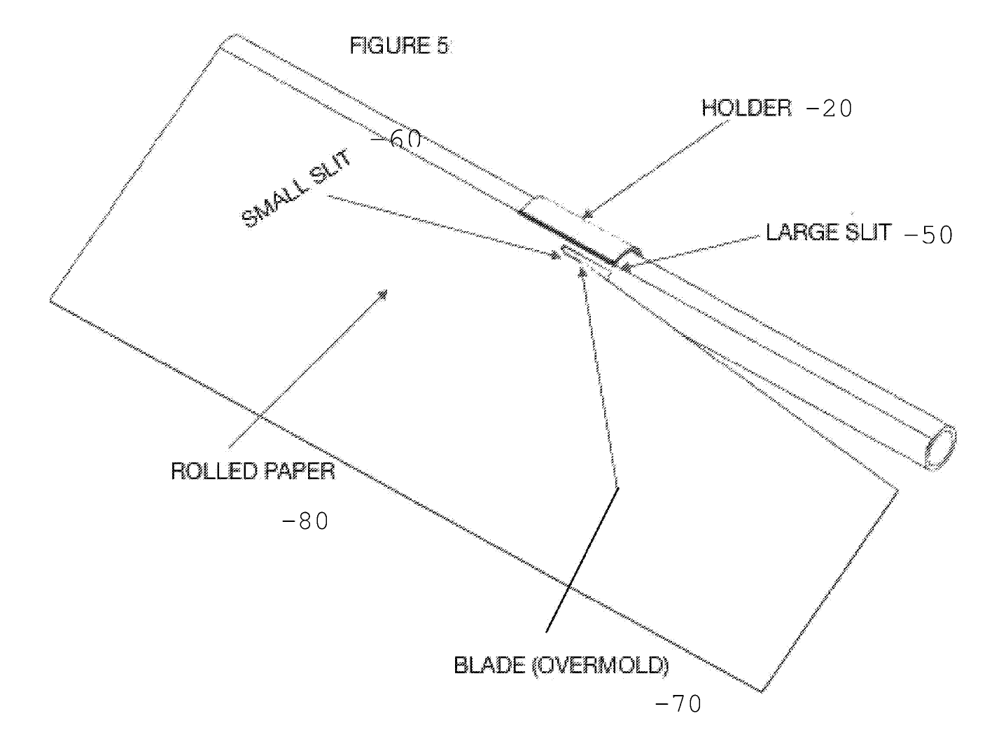

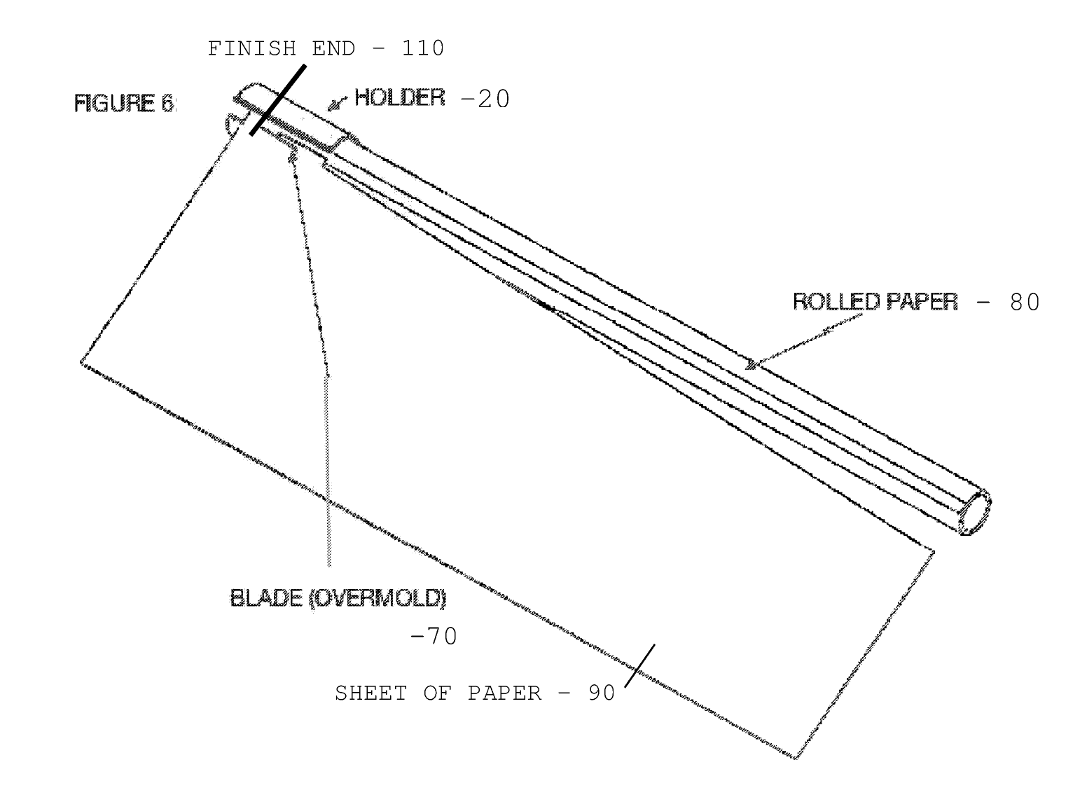

The method of using the rolled paper cutter device 10 involves sliding the paper cutter device 10 over the rolled paper 80 as seen in FIG. 4, FIG. 5, and FIG. 6. The hinge (living) 30 allows the paper cutter device 10 to be useful for variable circumfrences of rolled paper 80. Once the paper cutter device 10 is in place, as shown in FIG. 4, the paper cutter device 10 can be slid over the rolled paper 80.

Once the holder 20 is positioned around the rolled paper 80, as also shown in FIG. 4, the sheet of paper 90 is extended through the full length dispensing interstice (large slit) 50 to the desired length. Following this, the paper cutter device 10 is placed at the starting end 100 of the rolled paper 80 allowing the extended sheet of paper 90 to engage with the partial length knife engagement interstice (small slit) 60 where the knife blade (overmold) 70 is located. In this manner, the sheet of paper 90 is positioned to be cut, with the holder 20 in the starting end 100 of the rolled paper 80 and the sheet of paper 90 engaged with the knife blade (overmold) 70 that is embedded at the closed end of the partial length knife engagement interstice (small slit) 60.

At this point, the holder 20 is moved forward as seen in FIG. 5 and FIG. 6, engaging the sheet of paper 90 with the knife blade 70 which slices the sheet of paper 90 off of the rolled paper 80. As the paper cutter device 10 is slid forward, the sheet of paper 90 comes in contact with the knife blade 70 which causes the sheet of paper 90 to detach from the rolled paper 80. When the sheet of paper 90 is completely disengaged from the rolled paper 80, the paper cutter device 10 having moved from the starting end 100 of the rolled paper 80 to the finish end 110 of the rolled paper 80 and the sheet of paper 90, as shown in FIG. 6, is disengaged from the rolled paper 80.

Finally, the holder 20 is positioned towards the center of the rolled paper 80, so, the paper cutter device 10 thereby provides a convenient means for holding the rolled paper 80 tightly, keeping the paper roll 80 from unravelling, unrolling or becoming disorganized.

It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desire to secure by Letters Patent is:

1. A paper cutting device comprising:
a. a tube with a circular cross section, the tube having an open front end, an open back end and a middle section between the front end and the back end; and having a top portion and a bottom portion, the portions separated from each other by a full length dispensing interstice on one side and a hinge on the other side;
b. the full length dispensing interstice running axially along one side of the tube from the front end to the back end, and defined by a first edge of the top portion of the tube and a first edge of the bottom portion of the tube;
c. the hinge running axially along one side of the tube from the front end to the back end and running parallel to the full length dispensing interstice, the hinge defining a second edge of the top portion of the tube and a second edge of the bottom portion of the tube, the hinge allowing for variations in the width of the interstice when the top portion of the tube is pivoted with respect to the bottom portion of the tube about the axis of the hinge;
d. a paper cutting knife blade attached to the first edge of the bottom portion of the tube, between the front end and the back end, the knife blade extending into the interstice, and which blade includes a sharp edge which faces towards the front end of the tube.

2. A paper cutting device as recited in claim 1 wherein the tube is made of durable plastic.

3. A paper cutting device as recited in claim 1 wherein the first edge of the top portion of the tube includes along its entire length a protrusion extending axially out from the wall of the tube.

4. A paper cutting device as recited in claim 1 wherein the paper cutting knife blade is an overmold embedded in the tube material except that the front facing sharp edge of the knife blade is exposed in the direction of the front end of the tube.

5. A paper cutting device as recited in claim 1 further comprising a partial length knife engagement interstice, open towards the front end of the device and closed towards the back facing end, within which interstice the front facing blade is attached and which interstice is located along the first edge of the bottom portion of the tube, forming a paper cutting guide, separate from and along side the full length dispensing interstice and also following the axis of the tube.

6. A paper cutter device as recited in claim 1 wherein the hinge is a living hinge.

7. A paper cutting device comprising:
a. a tube made of durable plastic with a circular cross section, the tube having an open front end, an open back end and a middle section between the front end and the back end; and having a top portion and a bottom portion separated from each other by an interstice on one side and a hinge on the other side;
b. a full length dispensing interstice running axially along one side of the tube from the front end to the back end, and defined by a first edge of the top portion of the tube which first edge includes along its entire length a protrusion extending axially out from the wall of the tube and a first edge of the bottom portion of the tube;
c. a partial length knife engagement interstice, open towards the front end of the device and closed towards the back facing end, within which interstice a front facing blade is attached and which partial length knife engagement interstice is located along the first edge of the bottom portion of the tube, forming a paper cutting guide, separate from and along side the full length dispensing interstice and also following the axis of the tube;
d. a living hinge running axially along one side of the tube from the front end to the back end and running parallel to the full length dispensing interstice, the hinge defining a second edge of the top portion of the tube and a second edge of the bottom portion of the tube, the hinge allowing for variations in the width of the interstice when the top portion of the tube is pivoted about the axis of the hinge;
e. a paper cutting knife blade attached to the first edge of the bottom portion of the tube, between the front end and the back end, the knife blade extending into the interstice, and which blade includes a sharp edge, which sharp edge faces towards the front end of the tube and which knife blade is an overmold embedded in the tube material, except that the front facing sharp edge of the knife blade is exposed in the direction of the front end of the tube.

8. A method of cutting rolled paper into sheets of paper comprising the steps of:
a. using a paper cutting device, which device comprising: a tube with a circular cross section, the tube having an open front end, an open back end and a middle section between the front end and the back end, and having a top portion and a bottom portion separated from each other by a full length dispensing interstice on one side of the tube and a hinge on the other side of the tube, the full length dispensing interstice running axially along one side of the tube from the front end to the back end, and defined by a first edge of the top portion of the tube and a first edge of the bottom portion of the tube, the hinge running axially along one side of the tube from the front end to the back end and running parallel to the full length dispensing interstice, the hinge defining a second edge of the top portion of the tube and a second edge of the bottom portion of the tube, the hinge allowing for variations in the width of the interstice when the top portion of the tube is pivoted about the axis of the hinge; a knife blade attached to the first edge of the bottom portion of the tube, between the front end and the back end of the tube, the knife blade extending into the interstice, and which blade includes a sharp edge which faces towards the front end of the tube;
b. positioning the paper cutting device around the rolled paper;
c. extending a free end of the rolled paper through the full length paper dispensing interstice to a desired length to present a side edge of the free end of the rolled paper to the knife blade;
d. engaging the side edge of the free end of the rolled paper with the knife blade;
e. moving the paper cutting device in the direction of the side edge; and
f. detaching the free end of the rolled paper from the rolled paper.
